(19) United States
(12) Patent Application Publication
(10) Pub. No.: US 2010/0021046 A1
(43) Pub. Date: Jan. 28, 2010

(54) PATTERN INSPECTION APPARATUS, PATTERN INSPECTION METHOD AND COMPUTER READABLE RECORDING MEDIUM

(76) Inventor: Ichirota Nagahama, Koga-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/509,101

(22) Filed: Jul. 24, 2009

(30) Foreign Application Priority Data
Jul. 25, 2008 (JP) 2008-192218

(51) Int. Cl. G06K 9/00

(52) U.S. Cl. 382/145

(57) ABSTRACT

A pattern inspection apparatus includes: an inspection threshold setting unit to set a defect detection threshold to be used in inspection of an inspection pattern by referring to design information of an inspection layer which is included in a plurality of layers on a substrate and which has the inspection pattern formed thereon, and design information of an adjacent layer which is one of two layers adjacent to the inspection layer in a normal line direction of the substrate; a deviation amount calculation unit to receive an image containing the inspection layer and the adjacent layer, detect edges of the image, and calculate a deviation amount between an edge of the inspection pattern and an edge of a pattern of the adjacent layer; and a defect determination unit to determine whether there is a defect in the inspection pattern by comparing the calculated deviation amount with the defect detection threshold.

### CROSS REFERENCE TO RELATED APPLICATION

This application claims benefit of priority under 35 USC §119 to Japanese patent application No. 2008-192218, filed on Jul. 25, 2008, the contents of which are incorporated by reference herein.

### BACKGROUND OF THE INVENTION

1. Field of the Invention

The present invention relates to a pattern inspection apparatus, a pattern inspection method and a computer readable recording medium.

2. Related Background Art

In recent years, an inspection technique of the die to database scheme has been proposed as a method of inspecting defects of patterns formed on a wafer. In the inspection technique of the die to database scheme, an edge of a secondary electron image obtained by scanning the wafer with an electron beam is compared with a pattern edge of design data, and a deviation amount between them is inspected (for example, Japanese Patent Laid-Open Pub. No. 2007-149055).

In Accordance with the technique disclosed in Japanese Patent Laid-Open Pub. No. 2007-149055, a deviation amount between an edge of design data of a via contact and an edge of a secondary electron image of the via contact is calculated, and a decision is made whether there is a defect by comparing the deviation amount with a definite deviation threshold.

However, the technique disclosed in Japanese Patent Laid-Open Pub. No. 2007-149055 has a problem that a definite value is adopted as the deviation threshold to detect a defect and consequently even a defect which does not originally affect device characteristics is detected and the number of defects becomes enormous. The technique disclosed in Japanese Patent Laid-Open Pub. No. 2007-149055 also has a problem that the deviation threshold is determined by using the try and error technique in which an inspection is actually conducted and its result is ascertained and consequently enormous time and labor are required to set inspection conditions.

### SUMMARY OF THE INVENTION

In accordance with a first aspect of the present invention, there is provided a pattern inspection apparatus comprising:

an inspection threshold setting unit to set a defect detection threshold to be used in inspection of an inspection pattern by referring to design information of an inspection layer which is included in a plurality of layers on a substrate and which has the inspection pattern formed thereon, and design information of an adjacent layer which is one of two layers adjacent to the inspection layer in a normal line direction of the substrate;

a deviation amount calculation unit to receive an image containing the inspection layer and the adjacent layer, detect edges of the image, and calculate a deviation amount between an edge of the inspection pattern and an edge of a pattern of the adjacent layer; and

a defect determination unit to determine whether there is a defect in the inspection pattern by comparing the calculated deviation amount with the defect detection threshold.

In accordance with a second aspect of the present invention, there is provided a pattern inspection method comprising:

setting an inspection detection threshold to be used in inspection of an inspection pattern by referring to design information of an inspection layer which is included in a plurality of layers on a substrate and which has the inspection pattern formed thereon, and design information of an adjacent layer which is one of two layers adjacent to the inspection layer in a normal line direction of the substrate;

detecting edges of an image containing the inspection layer and the adjacent layer, and calculating a deviation amount between an edge of the inspection pattern and an edge of a pattern of the adjacent layer; and

comparing the calculated deviation amount with the defect detection threshold to determine whether there is a defect in the inspection pattern.

### BRIEF DESCRIPTION OF THE DRAWINGS

FIG. 1 is a block diagram showing a schematic configuration of an embodiment of a pattern inspection apparatus according to the present invention;

FIGS. 2 and 3 are flow charts showing an outline of a series of processes of an embodiment of a pattern inspection method according to the present invention;

FIG. 4 is a diagram showing a specific example of a design pattern of an inspection pattern; and

FIGS. 5 to 7 are diagrams explaining the series of processes shown in FIG. 3.

### DETAILED DESCRIPTION OF THE INVENTION

Embodiments of the present invention will be described with reference to the drawings. In the drawings, the same parts are denoted by like reference numbers, and duplicated description thereof will not be described except when the occasion demands.

### (1) One Embodiment of Pattern Inspection Apparatus

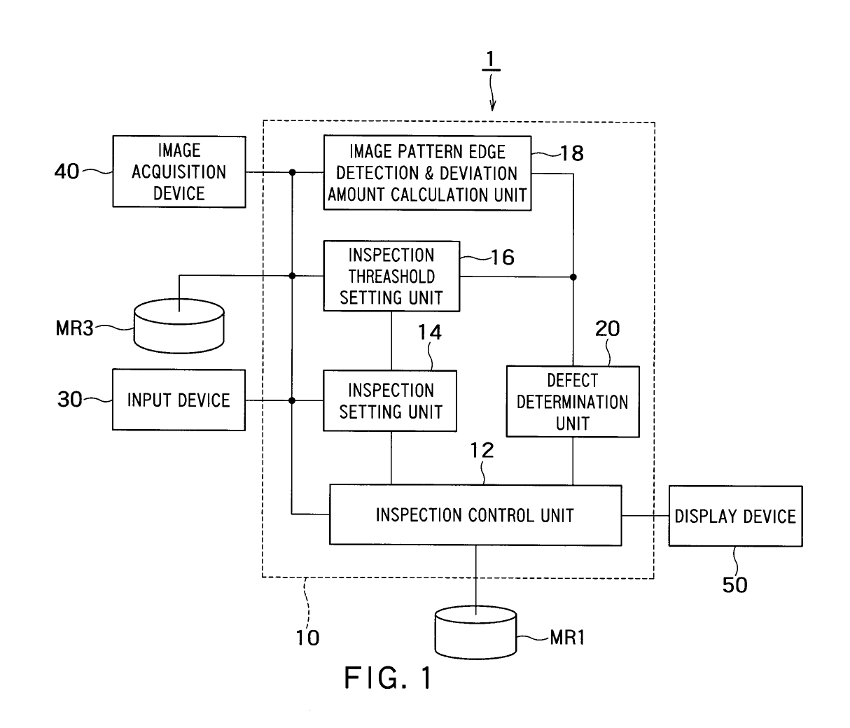

FIG. 1 is a block diagram showing a schematic configuration of an embodiment of a pattern inspection apparatus according to the present invention. A pattern inspection apparatus 1 shown in FIG. 1 includes a control computer 10, an input device 30, an image acquisition device 40, a display device 50, and storage devices MR1 and MR3.

The control computer 10 includes an inspection control unit 12, an inspection setting unit 14, an inspection threshold setting unit 16, an image pattern edge detection & deviation amount calculation unit 18 and a defect determination unit 20.

The inspection control unit 12 is connected to all components shown in FIG. 1, i.e., the input device 30, the image acquisition device 40, the display device 50, the storage devices MR1 and MR3, the inspection setting unit 14, the inspection threshold setting unit 16, the image pattern edge detection & deviation amount calculation unit 18 and the defect determination unit 20 to generate a control signal and control these components. The inspection control unit 12 draws out a recipe file from the storage device MR1, and executes a pattern inspection according to a procedure described in the recipe file. A series of processes of an embodiment of a pattern inspection method according to the present invention described later is described in this recipe file.

Upon receiving a control signal from the inspection control unit 12, the image acquisition device 40 acquires an image of an inspection pattern. In the present embodiment, the inspection pattern is formed on an uppermost layer of a wafer formed by laminating a plurality of layers. The kind and scheme of the image acquisition device 40 do not matter as long as it can acquire an image of an inspection pattern. However, it is desirable that the image acquisition device 40 is a Scanning Electron Microscope (SEM) device because of its high resolution. In the present embodiment, a SEM device of a stage drive scheme which has an X-Y stage to place a wafer thereon and which moves an inspection region of the wafer by driving the X-Y stage is used. As a matter of course, however, the image acquisition device is not restricted to such a mode. For example, an image pickup device using X-rays can also be used.

The storage device MR1 has a plurality of storage regions. The storage device MR1 stores a result of a decision made about the inspection pattern by the defect determination unit. Besides, the storage device MR1 also stores a recipe file which describes a series of processes of an embodiment of a pattern inspection method according to the present invention described later.

The storage device MR3 stores design data of the inspection pattern. In the present embodiment, the design data is described in the format of GDSII.

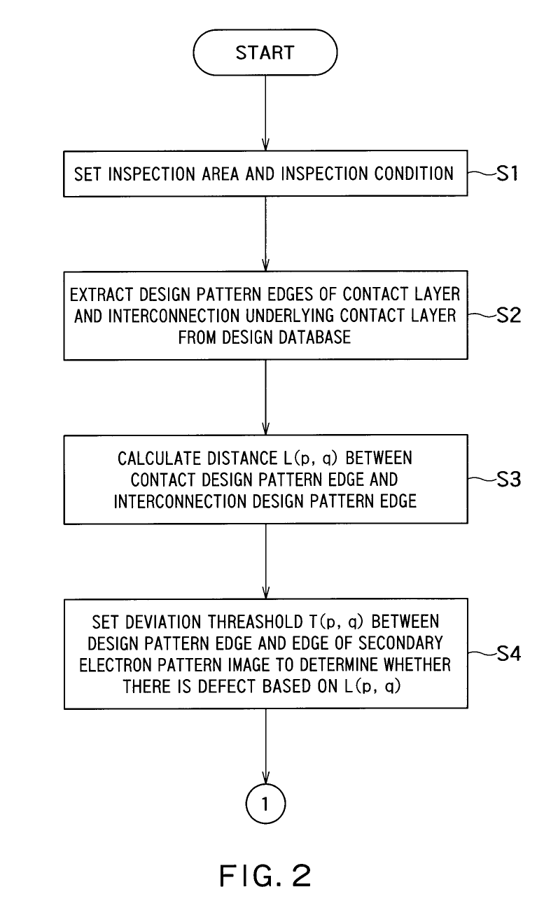

The inspection setting unit 14 receives a data input via the input device 30, and sets an inspection area and an inspection condition. The inspection threshold setting unit 16 draws out the design data of the inspection pattern from the storage device MR3 and sets a threshold for the defect inspection according to the series of processes (FIG. 2) described later. The image pattern edge detection & deviation amount calculation unit 18 receives a secondary electron image on the uppermost layer of the wafer including the inspection pattern supplied from the image acquisition device 40 (hereafter referred to as “secondary electron pattern image”), and detects an edge of the secondary electron pattern image. In addition, the image pattern edge detection & deviation amount calculation unit 18 draws out design data of the inspection pattern, and calculates a deviation amount between an edge of the design pattern and an edge of the secondary electron pattern image. In the present embodiment, the image pattern edge detection & deviation amount calculation unit 18 corresponds to, for example, a deviation amount calculation unit. The fault decision unit 20 receives deviation amount data input from the image pattern edge detection & deviation amount calculation unit 18, further receives the threshold data input from the inspection threshold setting unit 16, and makes a decision whether there is a defect in the inspection pattern by comparing them with each other. A result of the decision is displayed on a liquid crystal display or the like by the display device 50 via the inspection control unit 12.

Hereafter, more detailed operation of the pattern inspection apparatus according to the present embodiment will be described as an embodiment of a pattern inspection method according to the present invention with reference to FIGS. 2 to 7.

### (2) One Embodiment of Pattern Inspection Method

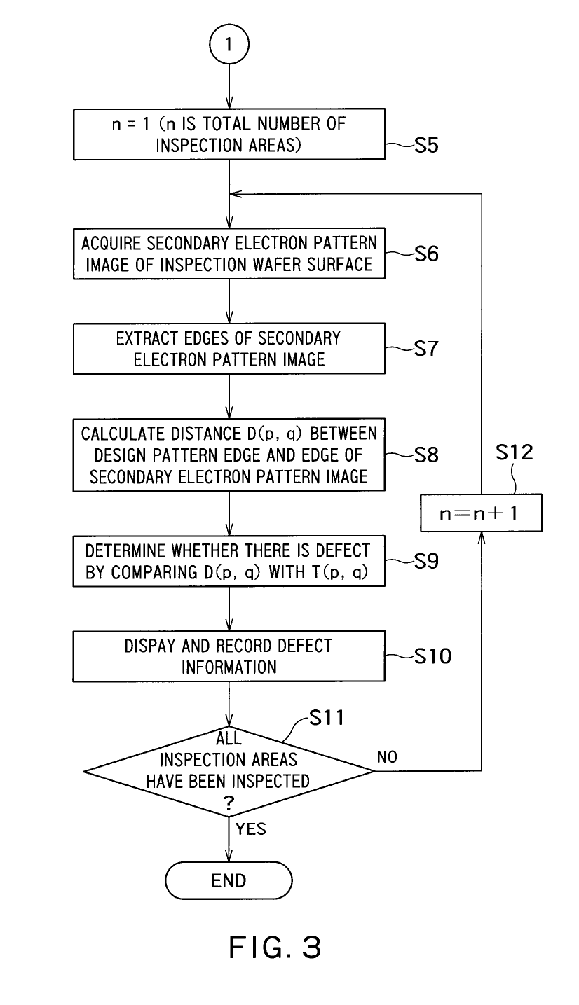

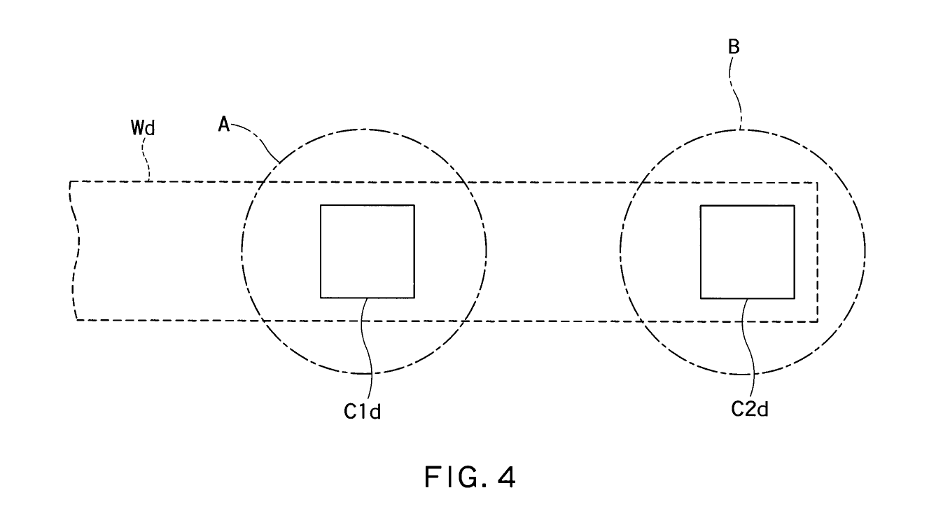

FIGS. 2 and 3 are flow charts showing an outline of a series of processes of an embodiment of a pattern inspection method according to the present invention. Hereafter, the embodiment will be described by taking via contacts connected to interconnection on an underlying layer as an example as shown in FIG. 4. FIG. 4 shows edges of an interconnection and two via contacts on design data. A dash line pattern denoted by Wd in FIG. 4 represents an edge of the interconnection on the design data. Solid line patterns denoted by C1d and C2d represent edges of the two via contacts on the design data.

A feature of the present embodiment is that the threshold for defect detection is varied according to the degree of danger in the process as represented by step S4 in FIG. 2. The degree of danger in the process depends upon the relative positional relation between the inspection pattern and a pattern on a layer adjacent in a direction of a normal line of the wafer to a layer on which the inspection pattern is formed. For example, even if the via contact C1d is shifted in the lengthwise direction of the interconnection Wd, i.e., in the lateral direction in the sheet of FIG. 4 by misalignment or the like in a region A surrounded by a one-dot dash line in the pattern shown in FIG. 4, the degree of danger in the process is low. In contrast to this, in the breadthwise direction of the interconnection Wd, slight misalignment reduces the contact area and exerts a bad influence upon characteristics of a final product due to an increase of the temperature value or the like, and consequently the degree of danger in the process is high. In a region B surrounded by a one-dot dash line shown in FIG. 4, the via contact C2d is formed in an end part of the interconnection Wd. If the via contact C2d is shifted in a direction so as to project to the outside from the interconnection Wd by misalignment even in the lengthwise direction of the interconnection Wd, therefore, a bad influence is exerted upon characteristics of a final product. Also in this case, the degree of danger in the process is high. On the other hand, in directions directed toward inside of the interconnection Wd among lengthwise directions of the interconnection Wd, the degree of danger in the process is low even if a shift is caused by misalignment. A gentle threshold may be adopted in a place where the degree of danger in the process is thus low. On the other hand, a stricter threshold must be set in a place where the degree of danger in the process is high. In the conventional art, the threshold for defect detection is set to a uniform value and consequently the problem described above is caused. In the present embodiment, however, attention is paid to such relative positional relations between patterns, and the threshold for defect detection is varied according to the degree of danger in the process which depends upon the relative positional relations. As a result, automation of the threshold setting is made possible and, in addition, it is made possible to raise both the precision and efficiency of pattern inspection.

A series of processes in the pattern inspection method according to the present embodiment as far as threshold setting will now be described with reference to FIG. 2.

First, an operator inputs a signal for inspection setting from the input device 30 to the inspection setting unit 14. Thereupon, the inspection setting unit 14 acquires design data of the inspection pattern from the storage device MR3. The acquired design data is displayed by the display device 50 via the inspection control unit 12. The operator inputs data required for apparatus setting such as the inspection area and inspection condition from the input device 30 to the inspection setting unit 14 (step S1). Hereafter, it is supposed that there are n (where n is a natural number) inspection areas on the wafer.

Subsequently, the inspection threshold setting unit 16 extracts design pattern edges of a via contact layer and interconnection underlying the via contact layer from a design database stored in the storage device MR3 (step S2).

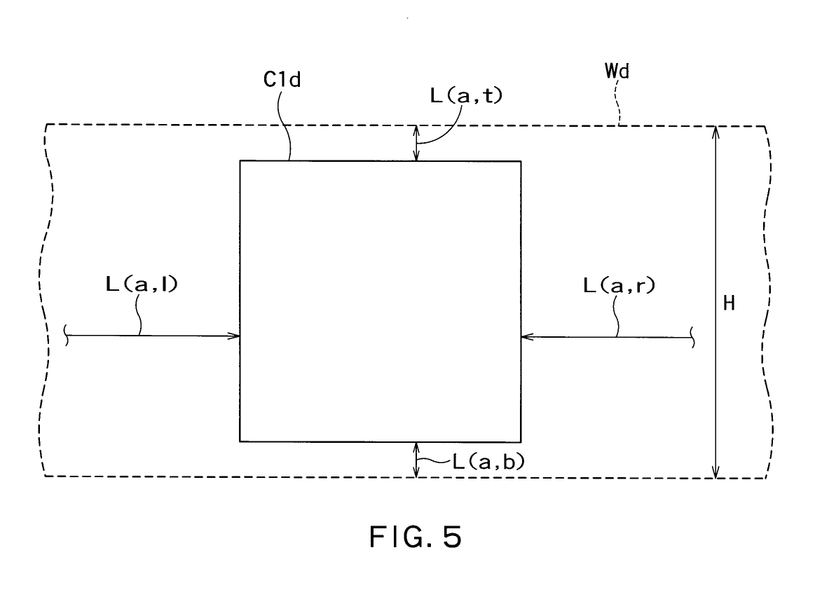

More specifically with reference to an example shown in FIG. 5, the inspection threshold setting unit 16 extracts a design pattern edge C1d of the via contact C1 and a design pattern edge Wd of the underlying layer interconnection W.

Subsequently, the inspection threshold setting unit 16 calculates a distance L (p, q) (where p is a pattern number, and q is a direction of a deviation amount) between the design pattern edge C1d and the design pattern edge Wd (step S3 in FIG. 2). Here, the directions of the deviation amount are supposed to be four directions: t (upward direction of the display screen), b (downward direction of the display screen), l (leftward direction of the display screen) and r (rightward direction of the display screen (hereafter referred to simply as t (top), b (bottom), l (left) and r (right)). In the example in FIG. 5, L (a, t), L (a, b), L (a, l) and L (a, r) are shown.

Subsequently, the inspection threshold setting unit 16 determines a deviation threshold T (p, q) between a design pattern edge and an edge of the secondary electron pattern image to make a decision whether there is a defect in the inspection pattern based on the distance L (p, q) between the design pattern edge C1d and the design pattern edge Wd found at the step S3 (step S4). More specifically, the inspection threshold setting unit 16 sets the deviation threshold T(p, q) so as to satisfy the following equations, where H is the width of the interconnection and k is a fixed value, and supplies the deviation threshold T(p, q) to the defect determination unit 20.

If L(p, q)≦H, T(p, q)=k×L(p, q)

If L(p, q)>H, T(p, q)=H

Here, it is desirable that k is a value close to 1.

Subsequently, the process for making a defect decision on the inspection pattern by using the deviation threshold T (p, q) thus set will now be described with reference to FIG. 3.

First, n=1 is set (step S5). A secondary electron pattern image of the wafer surface is acquired by the image acquisition device 40 (step S6).

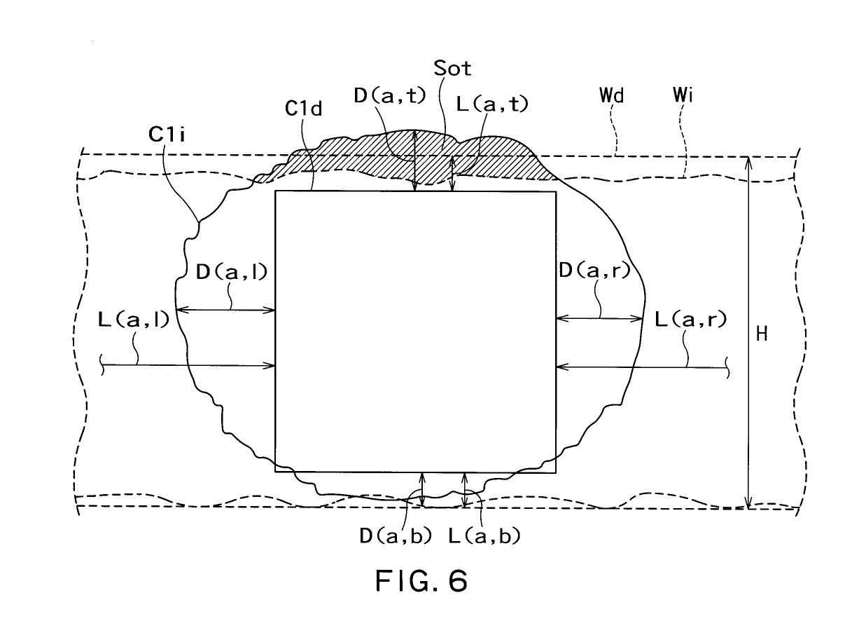

Subsequently, the image pattern edge detection & deviation amount calculation unit 18 receives a secondary electron pattern image supplied from the image acquisition device 40 and detects edges of the secondary electron pattern image (step S7). Subsequently, the image pattern edge detection & deviation amount calculation unit 18 calculates a distance D(p, q) (t(top), b(bottom), l(left) and r(right)) between the design pattern edge and the secondary electron pattern image edge, and supplies results of the calculation to the defect determination unit 20 (step S8). An example of the distance D (p, q) (t (top), b (bottom), l (left) and r (right)) thus calculated is shown in FIG. 6. FIG. 6 shows an example in which calculation is executed for the region A shown in FIG. 4 (p=a).

Subsequently, the defect determination unit 20 compares the distance D (p, q) with the deviation threshold T (p, q). If the distance D (p, q)≧the deviation threshold T (p, q), then the defect determination unit 20 judges the inspection pattern to have a defect (step S9 in FIG. 3). In FIG. 6, reference sign C1i represents an edge of the via contact C1 in the secondary electron pattern image and reference sign Wi represents an edge of the interconnection in the secondary electron pattern image. Reference sign Sot denotes a non-overlapping region of the via contact C1i and the interconnection Wi. In a place where an overlapping region of the via contact C1 and the interconnection thus becomes small, the deviation threshold T (a, t) is set equal to a small value which is nearly equal to the distance L (p, q). Therefore, this part can be judged to be a defective place.

Upon judging a defect to be present, the defect determination unit 20 causes the display device 50 to display the position of the defect, the deviation amount, edges of the design pattern and edges of the secondary electron pattern image via the inspection control unit 12. In addition, the defect determination unit 20 stores them in the storage device MR1 (step S10 in FIG. 3).

The pattern inspection apparatus 1 conducts the series of processes heretofore described until all inspection areas have been inspected (steps S11 and S12 in FIG. 3).

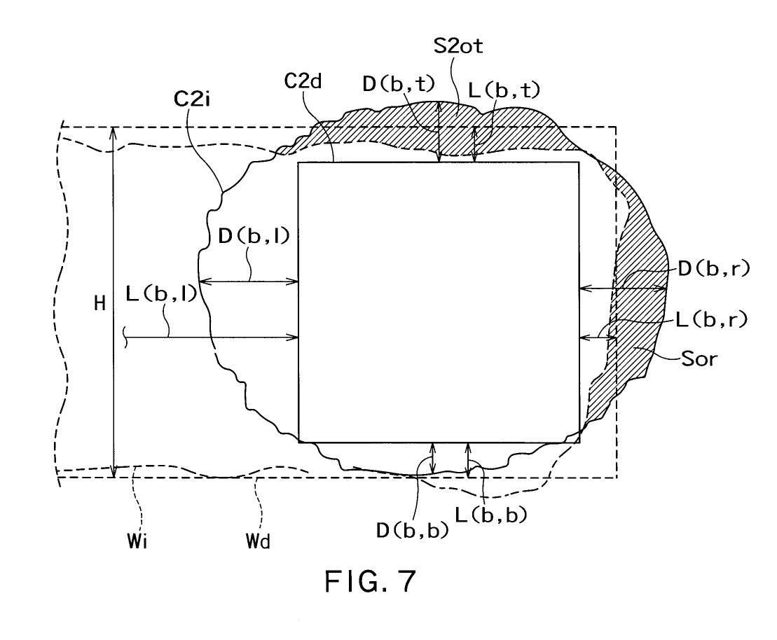

The distance D(p, q) in FIG. 4 and the deviation threshold T(p, q) which are each calculated and set for the region B are shown in FIG. 7 (p=b). In the example shown in FIG. 7, an edge C2i of a via contact C2 in the secondary electron pattern image protrudes from an edge Wi of the interconnection, in a region S2ot illustrated in an upper part of the sheet. A place including this non-overlapping portion is judged to be a defective place. In the example shown in FIG. 7, an edge C2i of the via contact C2 included in the edges of the secondary electron pattern images protrudes to the outside (the right side of paper) from the edge Wi of the interconnection in a Sor on the right side of the sheet as well, besides the region S2ot. A place including this non-overlapping portion is also judged to be a defective place. In the example shown in FIG. 7, a direction directed from an end of the interconnection to the right side of the sheet corresponds to, for example, a first direction, and a direction directed from the other end of the interconnection to the left side of the sheet corresponds to, for example, a second direction in contrast to the first direction.

### (3) Program

In the above-described embodiments, a series of procedures of the pattern inspection method are stored in the storage device MR1 as a recipe file, read into the control computer 10 in the pattern inspection apparatus 1, and executed. However, the series of procedures of the pattern inspection method may be incorporated into a program, read into a general purpose computer, and executed. As a result, the pattern inspection method according to the present invention can be implemented by using a general purpose computer which can conduct image processing. It is also possible to store the series of procedures of the pattern inspection method in a recording medium such as a flexible disk or a CD-ROM as a program to be executed by a computer, and cause a general purpose computer which is capable of conducting image processing to read the program and execute the program.

The recording medium is not restricted to a portable medium such as a magnetic disk or an optical disk, but may be a stationary recording medium such as a hard disk device or a memory. A program having the series of procedures of the pattern inspection method incorporated therein may also be distributed via a communication line such as Internet (inclusive of wireless communication).

### (4) Semiconductor Device Manufacturing Method

When the pattern inspection method mentioned above is used in a manufacturing process of a semiconductor device, a pattern can be inspected with high accuracy and high efficiency, the semiconductor device can be manufactured with a higher throughput and a higher yield ratio.

More specifically, a wafer is sampled in units of production lot, and a pattern formed on the sampled wafer is inspected based on the above-explained inspection method. When the pattern is determined as a non-defective pattern as a result of the inspection, the remaining manufacturing process is continuously performed with respect to the entire production lot to which the sampled wafer belongs to. On the other hand, when the pattern is determined as a defective pattern as a result of the inspection and rework processing is possible, the rework processing is performed with respect to the production lot to which the wafer having the pattern determined as a defective pattern formed thereon belongs to. Upon completion of the rework processing, a wafer is again sampled from the production lot to again inspect a pattern. When the sampled wafer is determined as a non-defective unit in the re-inspection of the pattern, the remaining manufacturing process is implemented with respect to the production lot on which the rework processing is finished. Further, when the rework processing is impossible, the production lot to which the wafer having the pattern determined as a defective pattern belongs to is discarded. When a defect occurrence factor can be analyzed, an analysis result is fed back to, e.g., a person in charge of design or a person in charge of upstream processes.

### (5) Rest

Heretofore, embodiments of the present invention have been described. However, the present invention is never restricted to the embodiments. As a matter of course, the present invention can be modified and applied in many ways within the scope thereof.

For example, in the above-described embodiments, the case where the pattern inspection apparatus 1 includes the image acquisition device 40 has been described. However, such an image acquisition device is never indispensable in the present invention. It is also possible to supply an image acquired by an external image acquisition device to the image pattern edge detection & deviation amount calculation unit 18 and cause it to detect an edge of the image.

In the embodiments, the case where an under layer is the interconnection layer and its upper layer is the via contact layer serving as an inspection layer has been described. As a matter of course, however, the present invention can also be applied to the case where an upper layer of the inspection layer is the interconnection layer. The present invention can also be applied to the case where both the inspection layer and its adjacent layer are via contact layers. In addition, the present invention is not restricted to the combination of the via contact and interconnection. For example, the present invention can also be applied to the case where an impurity diffusion layer such as source and drain is formed under an inspection layer on which via contacts are formed.

What is claimed is:

1. A pattern inspection apparatus comprising:
an inspection threshold setting unit to set a defect detection threshold to be used in inspection of an inspection pattern by referring to design information of an inspection layer which is included in a plurality of layers on a substrate and which has the inspection pattern formed thereon, and design information of an adjacent layer which is one of two layers adjacent to the inspection layer in a normal line direction of the substrate;
a deviation amount calculation unit to receive an image containing the inspection layer and the adjacent layer, detect edges of the image, and calculate a deviation amount between an edge of the inspection pattern and an edge of a pattern of the adjacent layer; and
a defect determination unit to determine whether there is a defect in the inspection pattern by comparing the calculated deviation amount with the defect detection threshold.

2. The apparatus of claim 1, wherein the inspection threshold setting unit sets the defect detection threshold according to a degree of danger in a process which depends upon a relative positional relations between the inspection pattern of the inspection layer and the pattern of the adjacent layer.

3. The apparatus of claim 1,
wherein the inspection layer is a layer of a via contact and the adjacent layer is a layer of interconnection, and the inspection threshold setting unit sets the defect detection threshold in a width direction and a length direction of the interconnection independently of each other.

4. The apparatus of claim 1,
wherein the via contact is designed to be connected to an end part of the interconnection, and
the inspection threshold setting unit sets the defect detection threshold in a length direction of the interconnection individually for each of a first direction directed from the end of the interconnection toward outside of the interconnection and a second direction directed from the end of the interconnection toward inside of the interconnection.

5. The apparatus of claim 1, wherein each of the inspection layer and the adjacent layer is an interconnection layer.

6. The apparatus of claim 1, wherein each of the inspection layer and the adjacent layer is a via contact layer.

7. The apparatus of claim 1, wherein the inspection layer is a via contact layer and the adjacent layer is an impurity diffusion layer located under the inspection layer.

8. A pattern inspection method comprising:
setting an inspection detection threshold to be used in inspection of an inspection pattern by referring to design information of an inspection layer which is included in a plurality of layers on a substrate and which has the inspection pattern formed thereon, and design information of an adjacent layer which is one of two layers adjacent to the inspection layer in a normal line direction of the substrate;
detecting edges of an image containing the inspection layer and the adjacent layer, and calculating a deviation amount between an edge of the inspection pattern and an edge of a pattern of the adjacent layer; and
comparing the calculated deviation amount with the defect detection threshold to determine whether there is a defect in the inspection pattern.

9. The method of claim 8,
wherein the defect detection threshold is set according to a degree of danger in a process which depends upon a relative positional relations between the inspection pattern of the inspection layer and the pattern of the adjacent layer.

10. The method of claim 8,
wherein the inspection layer is a layer of a via contact and the adjacent layer is a layer of interconnection, and the defect detection threshold is set in a width direction and a length direction of the interconnection independently of each other.

11. The method of claim 8,
wherein the via contact is designed to be connected to an end part of the interconnection, and
wherein the defect detection threshold in a length direction of the interconnection is set individually for each of a first direction directed from the end of the interconnection toward outside of the interconnection and a second direction directed from the end of the interconnection toward inside of the interconnection.

12. The method of claim 8,
wherein each of the inspection layer and the adjacent layer is an interconnection layer.

13. The method of claim 8,
wherein each of the inspection layer and the adjacent layer is a via contact layer.

14. The method of claim 8,
wherein the inspection layer is a via contact layer and the adjacent layer is an impurity diffusion layer located under the inspection layer.
